(19) United States
(12) Patent Application Publication
(10) Pub. No.: US 2016/0373763 A1
(43) Pub. Date: Dec. 22, 2016

(54) INTER PREDICTION METHOD WITH CONSTRAINED REFERENCE FRAME ACQUISITION AND ASSOCIATED INTER PREDICTION DEVICE

(71) Applicant: MEDIATEK INC., Hsin-Chu (TW)

(72) Inventors: Tung-Hsing Wu, Chiayi City (TW); Han-Liang Chou, Hsinchu County (TW)

(21) Appl. No.: 15/145,807

(22) Filed: May 4, 2016

Related U.S. Application Data
(60) Provisional application No. 62/181,421, filed on Jun. 18, 2015.

(51) Int. Cl. H04N 19/159; H04N 19/176; H04N 19/593; H04N 19/577

(52) U.S. Cl. CPC H04N 19/159; H04N 19/577; H04N 19/176; H04N 19/593

(57) ABSTRACT

An inter prediction method includes performing reference frame acquisition for inter prediction of a first frame in a first frame group to obtain at least one reference frame, and performing the inter prediction of the first frame according to the at least one reference frame. The at least one reference frame used by the inter prediction of the first frame is intentionally constrained to include at least one first reference frame obtained from reconstructed data of at least one second frame in the first frame group. The first frame group has at least one first frame, including the first frame, and the at least one second frame. Frames in the first frame group have a same image content but different resolutions.

### CROSS REFERENCE TO RELATED APPLICATIONS

This application claims the benefit of U.S. provisional application No. 62/181,421, filed on Jun. 18, 2015 and incorporated herein by reference.

### BACKGROUND

The present invention relates to inter prediction involved in video encoding and video decoding, and more particularly, to an inter prediction method with a constrained reference frame acquisition and an associated inter prediction device.

The conventional video coding standards generally adopt a block based coding technique to exploit spatial and temporal redundancy. For example, the basic approach is to divide a current frame into a plurality of blocks, perform prediction on each block, generate residual of each block, and perform transform, quantization, scan and entropy encoding for encoding the residual of each block. Besides, a reconstructed frame of the current frame is generated in a coding loop to provide reference pixel data that will be used for coding following frames. For example, inverse scan, inverse quantization, and inverse transform may be included in the coding loop to recover residual of each block of the current frame. When an inter prediction mode is selected, inter prediction is performed based on one or more reference frames (which are reconstructed frames of previous frames) to thereby find predicted samples of each block of the current frame. The residual of each block of the current frame is generated by subtracting the predicted samples of each block of the current frame from original samples of each block of the current frame. In addition, each block of a reconstructed frame of the current frame is generated by adding the predicted samples of each block of the current frame to the recovered residual of each block of the current frame. A video decoder is configured to perform an inverse of the video encoding performed at a video encoder. Hence, inter prediction is also performed in the video decoder for finding predicted samples of each block of a current frame to be decoded.

In accordance with the H.264 video coding standard, the resolution of each frame included in a single encoded bitstream can not be changed. In accordance with the VP8 video coding standard promoted by Google®, the resolution can be changed in an intra (key) frame of a single encoded bitstream. In accordance with the VP9 video coding standard promoted by Google®, the resolution can be changed in continuous inter frames. This feature is call resolution reference frame (RRF). In a Web Real-Time Communication (WebRTC) application, temporal scalability and spatial scalability are both needed for meeting different network bandwidth requirements. When the temporal scalability is enabled, a single encoded bitstream can provide multiple frames having the same resolution but corresponding to different temporal layers. Hence, when more temporal layers are decoded, a higher frame rate can be achieved. When the spatial scalability is enabled, a single encoded bitstream can provide multiple frames having the same image content but different resolutions. Hence, when a spatial layer with a larger spatial layer index is decoded, a higher resolution can be achieved. However, when temporal scalability and spatial scalability are both enabled, the reference frame structure for inter prediction becomes complicated, which results in a larger number of reference frame buffers required and a complicated buffer management design for reference frame buffers.

Thus, there is a need for an innovative reference frame structure that is suitable for temporal and spatial scalability and is capable of relaxing the reference frame buffer requirement.

### SUMMARY

One of the objectives of the claimed invention is to provide an inter prediction method with a constrained reference frame acquisition and an associated inter prediction device.

According to a first aspect of the present invention, an exemplary inter prediction method is disclosed. The exemplary inter prediction method includes performing reference frame acquisition for inter prediction of a first frame in a first frame group to obtain at least one reference frame, and performing the inter prediction of the first frame according to the at least one reference frame. The at least one reference frame used by the inter prediction of the first frame is intentionally constrained to include at least one first reference frame obtained from reconstructed data of at least one second frame in the first frame group. The first frame group has at least one first frame, including the first frame, and the at least one second frame. Frames in the first frame group have a same image content but different resolutions.

According to a second aspect of the present invention, an exemplary inter prediction method is disclosed. The exemplary inter prediction method includes performing reference frame acquisition for inter prediction of a first frame in a first frame group to obtain at least one reference frame, and performing the inter prediction of the first frame according to the at least one reference frame. The at least one reference frame used by the inter prediction of the first frame is intentionally constrained to comprise at least one first reference frame obtained from reconstructed data of at least one second frame in a second frame group. The first frame group includes frames with a same image content but different resolutions. The second frame group includes frames with a same image content but different resolutions. One frame in the first frame group and one frame in the second frame group have a same resolution. The at least one first reference frame includes a reference frame having a resolution different from a resolution of the first frame.

According to a third aspect of the present invention, an exemplary inter prediction device is disclosed. The exemplary inter prediction device includes a reference frame acquisition circuit and an inter prediction circuit. The reference frame acquisition circuit is arranged to perform reference frame acquisition for inter prediction of a first frame in a first frame group, wherein at least one reference frame used by the inter prediction of the first frame is intentionally constrained by the reference frame acquisition circuit to comprise at least one first reference frame obtained from reconstructed data of at least one second frame in the first frame group, the first frame group has at least one first frame, including the first frame, and the at least one second frame, and frames in the first frame group have a same image content but different resolutions. The inter prediction circuit is arranged to perform the inter prediction of the first frame according to the at least one reference frame.

According to a fourth aspect of the present invention, an exemplary inter prediction device is disclosed. The exemplary inter prediction device includes a reference frame acquisition circuit and an inter prediction circuit. The reference frame acquisition circuit is arranged to perform reference frame acquisition for inter prediction of a first frame in a first frame group to obtain at least one reference frame. The inter prediction circuit is arranged to perform the inter prediction of the first frame according to the at least one reference frame. The at least one reference frame used by the inter prediction of the first frame is intentionally constrained by reference frame acquisition circuit to comprise at least one first reference frame obtained from reconstructed data of at least one second frame in a second frame group. The first frame group includes frames with a same image content but different resolutions. The second frame group includes frames with a same image content but different resolutions. One frame in the first frame group and one frame in the second frame group have a same resolution. The at least one first reference frame comprises a reference frame having a resolution different from a resolution of the first frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an inter prediction device according to an embodiment of the present invention.

FIG. 2 is a diagram illustrating a first reference frame structure according to an embodiment of the present invention.

FIG. 3 is a diagram illustrating a second reference frame structure according to an embodiment of the present invention.

FIG. 4 is a diagram illustrating a third reference frame structure according to an embodiment of the present invention.

FIG. 5 is a diagram illustrating a fourth reference frame structure according to an embodiment of the present invention.

FIG. 6 is a diagram illustrating a fifth reference frame structure according to an embodiment of the present invention.

FIG. 7 is a diagram illustrating a sixth reference frame structure according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main concept of the present invention is imposing a constraint on reference frame acquisition (e.g., reference frame selection) that is used to obtain (e.g., select) one or more reference frames for inter prediction of frames encoded/decoded under temporal and/or spatial scaling. Since the reference frame acquisition (e.g., reference frame selection) is intentionally constrained, the number of reference frame buffers needed for buffering reference frames (e.g., reconstructed data of previously encoded/decoded frames) can be reduced to thereby relax the reference frame buffer requirement for implementing temporal and/or spatial scaling. In addition, the memory bandwidth required for encoding/decoding different temporal and/or spatial layers can also be reduced. Further details of the proposed reference frame structure for temporal and/or spatial scaling are described as below.

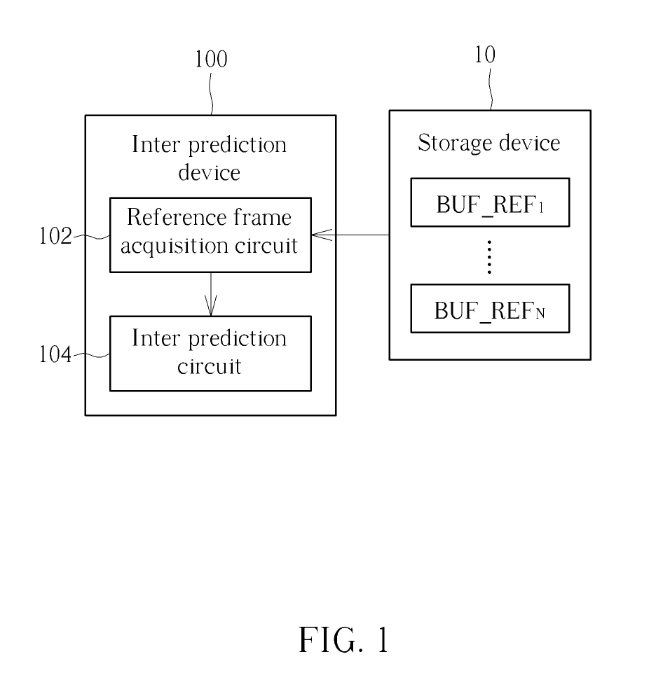

FIG. 1 is a diagram illustrating an inter prediction device according to an embodiment of the present invention. In one exemplary embodiment, the inter prediction device 100 may be part of a video encoder. In another exemplary embodiment, the inter prediction device 100 may be part of a video encoder. As shown in FIG. 1, the inter prediction device 100 includes a reference frame acquisition circuit 102 and an inter prediction circuit 104. When a current frame is being encoded/decoded, the reference frame acquisition circuit 102 is operative to obtain at least one reference frame stored in the storage device 10. The storage device 10 includes a plurality of reference frame buffers BUF_REF₁-BUF_REF_{N}, each arranged to store one reference frame that is a reconstructed frame (i.e., reconstructed data of a previous frame). For example, the storage device 10 may be implemented using a memory device such as a dynamic random access memory (DRAM) device. It should be noted that the number of reference frame buffers BUF_REF₁-BUF_REF_{N} depends on the reference frame structure employed for temporal and/or spatial scaling. In addition, the reference frame structure employed specifies the constrained reference frame acquisition performed by the reference frame acquisition circuit 102. Hence, the at least one reference frame used by inter prediction of the current frame is intentionally constrained by the reference frame acquisition circuit 102. After the at least one reference frame used by inter prediction of the current frame is obtained by the reference frame acquisition circuit 102, the inter prediction circuit 104 is operative to perform inter prediction of the current frame according to the at least one reference frame. Several exemplary reference frame structures are detailed as below.

In some embodiments of the present invention, the reference frame acquisition performed by the reference frame acquisition circuit 102 may include a reference frame selection arranged to select at least one single reference frame from one reference buffer in the storage device 10 or select multiple reference frames from a plurality of reference buffers in the storage device 10. Hence, in the following description, the terms “reference frame acquisition” and “reference frame selection” may be interchangeable, and the terms “obtain” and “select” may also be interchangeable.

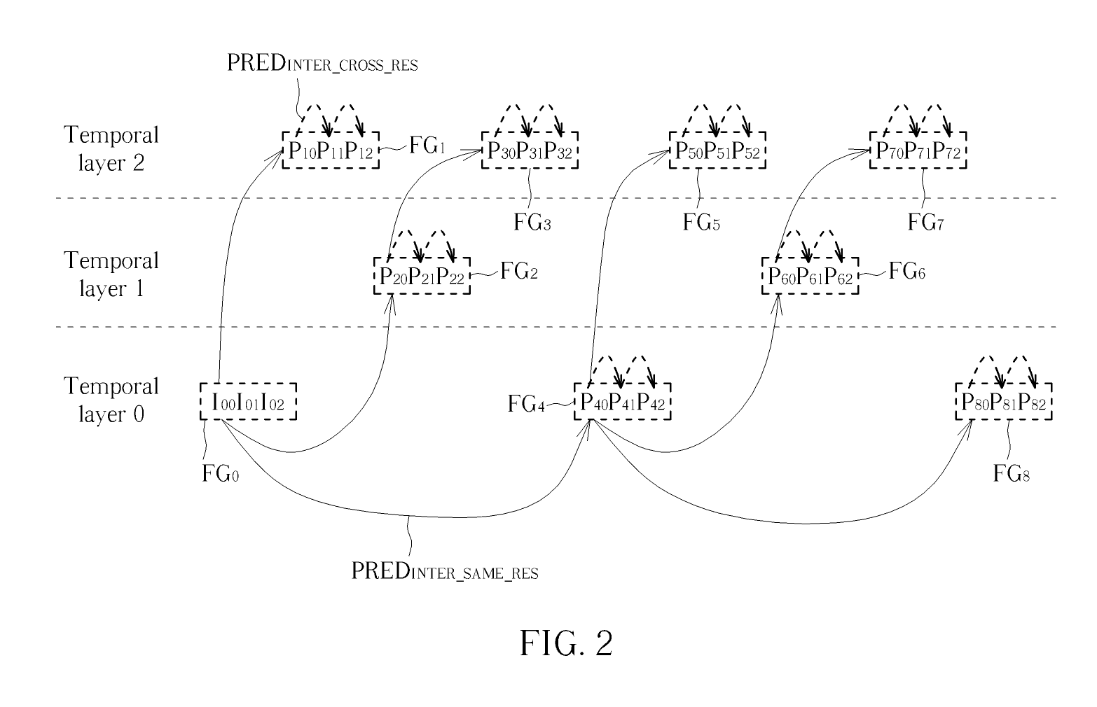

FIG. 2 is a diagram illustrating a first reference frame structure according to an embodiment of the present invention. In this embodiment, a reference frame structure for temporal scaling with at least two temporal layers and spatial scaling with at least two spatial layers is proposed. By way of example, but not limitation, the reference frame structure in FIG. 2 is applied to three temporal layers and three spatial layers. As shown in FIG. 2, there are frame groups FG₀-FG₈ each having a plurality of frames. The frame groups FG₀, FG₄ and FG₈ correspond to the same temporal layer with the temporal layer index “0”. The frame groups FG₂ and FG₆ correspond to the same temporal layer with the temporal layer index “1”. The frame groups FG₁, FG₃, FG₅ and FG₇ correspond to the same temporal layer with the same temporal layer index “2”. In addition, each frame is indexed by a two-digit frame index XY, where X is indicative of a frame group index and Y is indicative of a spatial layer index. It should be noted that, concerning each of the exemplary reference frame structures proposed in the present invention, frames in the same frame group have the same image content but different spatial layer indices (or different resolutions), and frames in different frame groups have different temporal layer indices or the same temporal layer index.

Taking the frame group FG₀ with the frame group index “0” for example, the frame I₀₀ has the temporal layer index “0” and the spatial layer index “0”, and contains a first image content with a first resolution; the frame I₀₁ has the temporal layer index “0” and the spatial layer index “1”, and contains the first image content with a second resolution larger than the first resolution; and the frame I₀₂ has the temporal layer index “0” and the spatial layer index “2”, and contains the first image content with a third resolution larger than the second resolution. Taking the frame group FG₁ with the frame group index “1” for example, the frame P₁₀ has the temporal layer index “2” and the spatial layer index “0”, and contains a second image content with the first resolution, where the second image content may be identical to or different from the first image content depending upon whether the video has motion; the frame P₁₁ has the temporal layer index “2” and the spatial layer index “1”, and contains the second image content with the second resolution larger than the first resolution; and the frame P₁₂ has the temporal layer index “2” and the spatial layer index “2”, and contains the second image content with the third resolution larger than the second resolution. Hence, frames I₀₀-I₀₂ in the same frame group FG₀ have the same first image content but different resolutions, and frames P₁₀-P₁₂ in the same frame group FG₁ have the same second image content but different resolutions. The frames I₀₀ and P₁₀ in different frame groups FG₀ and FG₁ have the same resolution but different temporal layer indices, the frames I₀₁ and P₁₁ in different frame groups FG₀ and FG₁ have the same resolution but different temporal layer indices, and the frames I₀₂ and P₁₂ in different frame groups FG₀ and FG₁ have the same resolution but different temporal layer indices.

Consider a first case where one temporal layer and one spatial layer are received and decoded in a WebRTC application. The frames I₀₀, P₄₀, P₈₀ are used to provide a video playback with a first frame rate and the first resolution if temporal layer 0 and spatial layer 0 are received and decoded; the frames I₀₁, P₄₁, P₈₁ are used to provide a video playback with the first frame rate and the second resolution if temporal layer 0 and spatial layer 1 are received and decoded; and the frames I₀₂, P₄₂, P₈₂ are used to provide a video playback with the first frame rate and the third resolution if temporal layer 0 and spatial layer 2 are received and decoded.

Consider a second case where two temporal layers and one spatial layer are received and decoded in a WebRTC application. The frames I₀₀, P₂₀, P₄₀, P₆₀, P₈₀ are used to provide a video playback with a second frame rate (which is higher than the first frame rate) and the first resolution if temporal layer 0, temporal layer 1 and spatial layer 0 are received and decoded; the frames I₀₁, P₂₁, P₄₁, P₆₁, P₈₁ are used to provide a video playback with the second frame rate and the second resolution if temporal layer 0, temporal layer 1 and spatial layer 1 are received and decoded; and the frames I₀₂, P₂₂, P₄₂, P₆₂, P₈₂ are used to provide a video playback with the second frame rate and the third resolution if temporal layer 0, temporal layer 1 and spatial layer 2 are received and decoded.

Consider a third case where three temporal layers and one spatial layer are received and decoded in a WebRTC application. The frames I₀₀, P₁₀, P₂₀, P₃₀, P₄₀, P₅₀, P₆₀, P₇₀, P₈₀ are used to provide a video playback with a third frame rate (which is higher than the second frame rate) and the first resolution if temporal layer 0, temporal layer 1, temporal layer 2 and spatial layer 0 are received and decoded; the frames I₀₁, P₁₁, P₂₁, P₃₁, P₄₁, P₅₁, P₆₁, P₇₁, P₈₁ are used to provide a video playback with the third frame rate and the second resolution if temporal layer 0, temporal layer 1, temporal layer 2 and spatial layer 1 are received and decoded; and the frames I₀₂, P₁₂, P₂₂, P₃₂, P₄₂, P₅₂, P₆₂, P₇₂, P₈₂ are used to provide a video playback with the third frame rate and the third resolution if temporal layer 0, temporal layer 1, temporal layer 2 and spatial layer 2 are received and decoded.

Since the present invention focuses on the reference frame acquisition (e.g., reference frame selection) for inter prediction, further description of the temporal and spatial scaling is omitted here for brevity.

As shown in FIG. 2, all frames I₀₀, I₀₁, I₀₂ in the same frame group FG₀ are intra frames. Hence, encoding/decoding of the frames I₀₀, I₀₁, I₀₂ needs intra prediction instead of inter prediction, and thus does not need to refer to reference frame(s) obtained by reconstruction of previous frame(s). However, concerning each of the frame groups FG₁-FG₈ shown in FIG. 2, all frames in the same frame are inter frames. In this example, encoding/decoding of each inter frame in the frame groups FG₁-FG₈ needs inter prediction that is constrained to use only a single reference frame obtained from reconstruction of one previous frame. Each of the frame groups FG₁-FG₈ contains only one out-group frame (e.g., one frame with the smallest resolution) and at least one in-group frame (e.g., two in-group frames each having a resolution larger than a resolution of the out-group frame). Inter prediction of the out-group frame in one frame group refers to a single reference frame provided by a different frame group, and inter prediction of each in-group frame in one frame group refers to a single reference frame provided by the same frame group.

In accordance with the reference frame structure illustrated in FIG. 2, the reference frame acquisition circuit 102 performs reference frame acquisition for inter prediction of an out-group frame in a frame group, and further performs reference frame acquisition for inter prediction of each in-group frame in the same frame group, where a single reference frame used by the inter prediction of the out-group frame is intentionally constrained to be an out-group reference frame obtained from reconstructed data of one frame in a different frame group, and a single reference frame used by the inter prediction of each in-group frame is intentionally constrained to be an in-group reference frame obtained from reconstructed data of one frame in the same frame group.

It should be noted that a temporal layer index of the obtained out-group reference frame is smaller than or the same as a temporal layer index of the out-group frame to be encoded/decoded. For example, when the out-group frame to be encoded/decoded has a temporal layer index “2”, the out-group reference frame with a temporal layer index “2” or “1” or “0” may be obtained; when the out-group frame to be encoded/decoded has a temporal layer index “1”, the out-group reference frame with a temporal layer index “1” or “0” may be obtained; and when the out-group frame has a temporal layer index “0”, the out-group reference frame with a temporal layer index “0” may be obtained.

Taking the frame group FG₂ shown in FIG. 2 for example, the frame P₂₀ with the spatial layer index “0” is an out-group frame, and the frame P₂₁ with the spatial layer index “1” and the frame P₂₂ with the spatial layer index “2” are in-group frames. When the frame P₂₀ is being encoded/decoded, the same resolution inter prediction PRED_{INTER}_{_}_{SAME}_{_}_{RES} (which is represented by a solid-line arrow symbol in FIG. 2) is performed upon the frame P₂₀ according to a single out-group reference frame provided by a frame group that is encoded/decoded earlier than the frame group FG₂. In accordance with the proposed reference frame structure shown in FIG. 2, a single out-group reference frame is provided by the nearest frame group with the same or smaller temporal layer index. As shown in FIG. 2, the single out-group reference frame needed by inter prediction of the frame P₂₀ is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₀ in the frame group FG₂ have the same spatial layer index and thus have the same resolution.

When the frame P₂₁ is being encoded/decoded, the cross resolution inter prediction PRED_{INTER}_{_}_{CROSS}_{_}_{RES} (which is represented by a broken-line arrow symbol in FIG. 2) is performed upon the frame P₂₁ according to a single in-group reference frame provided by the frame group FG₂. For example, the single in-group reference frame is obtained from reconstructed data of the frame P₂₀ (i.e., a reconstructed frame of previously encoded/decoded frame P₂₀), where the frames P₂₀ and P₂₁ in the same frame group FG₂ have different spatial layer indices and thus have different resolutions.

When the frame P₂₂ is being encoded/decoded, the cross resolution inter prediction PRED_{INTER}_{_}_{CROSS}_{_}_{RES} (which is represented by a broken-line arrow symbol in FIG. 2) is performed upon the frame P₂₂ according to a single in-group reference frame provided by the frame group FG₂. For example, the single in-group reference frame is obtained from reconstructed data of the frame P₂₁ (i.e., a reconstructed frame of previously encoded/decoded frame P₂₁), where the frames P₂₁ and P₂₂ in the same frame group FG₂ have different spatial layer indices and thus have different resolutions.

In one exemplary design, the out-group frame means a frame with the smallest resolution in the frame group. In another exemplary design, the inter prediction of the out-group frame refers to reconstructed data of a frame with a resolution equal to a resolution of the out-group frame. However, these are for illustrative purposes only, and are not meant to be limitations of the present invention.

In one exemplary design, the cross resolution inter prediction PRED_{INTER}_{_}_{CROSS}_{_}_{RES} of an in-group frame (e.g., frame P₂₁/P₂₂) may be performed under a prediction mode with a zero motion vector (i.e., ZeroMV mode). In another exemplary design, the cross resolution inter prediction PRED_{INTER}_{_}_{CROSS}_{_}_{RES} of an in-group frame (e.g., frame P₂₁/P₂₂) may be performed using a resolution reference frame (RRF) mechanism as proposed in VP9 video coding standard. In yet another exemplary design, the cross resolution inter prediction PRED_{INTER}_{_}_{CROSS}_{_}_{RES} of an in-group frame (e.g., frame P₂₁/P₂₂) only refers to reconstructed data of a frame with a smaller resolution in the same frame group. However, these are for illustrative purposes only, and are not meant to be limitations of the present invention.

When the proposed reference frame structure shown in FIG. 2 is employed, the minimum number of reference frame buffers required to be implemented in the storage device 10 for encoding/decoding all inter frames under temporal and spatial scaling may be three. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frame (e.g., P₄₀); when the frame P₂₁ is being encoded/decoded, reconstructed data of the frame I₀₀ is kept in the first reference frame buffer due to the fact that reconstructed data of the frame I₀₀ is needed by encoding/decoding of the following frame (e.g., P₄₀), and reconstructed data of the frame P₂₀ is kept in a second reference frame buffer due to the fact that reconstructed data of the frame P₂₀ is needed by encoding/decoding of the current frame and the following frame (e.g., P₃₀); and when the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame P₂₀ is kept in the second reference frame buffer due to the fact that reconstructed data of the frame P₂₀ is needed by encoding/decoding of the following frame (e.g., P₃₀), and reconstructed data of the frame P₂₁ is kept in in a third reference frame buffer due to the fact that reconstructed data of the frame P₂₁ is needed by encoding/decoding of the current frame.

However, when the proposed reference frame structure shown in FIG. 2 is employed for a different application (e.g., parallel encoding/decoding), the number of reference frame buffers required to be implemented in the storage device 10 for encoding/decoding all inter frames under temporal and spatial scaling may be larger than the aforementioned minimum value.

With regard to the proposed reference frame structure shown in FIG. 2, encoding/decoding of different in-group frames in the same frame group uses different in-group reference frames for cross resolution inter prediction. Alternatively, encoding/decoding of different in-group frames in the same frame group may use the same in-group reference frame for cross resolution inter prediction. In this way, the reference frame buffer requirement can be further reduced.

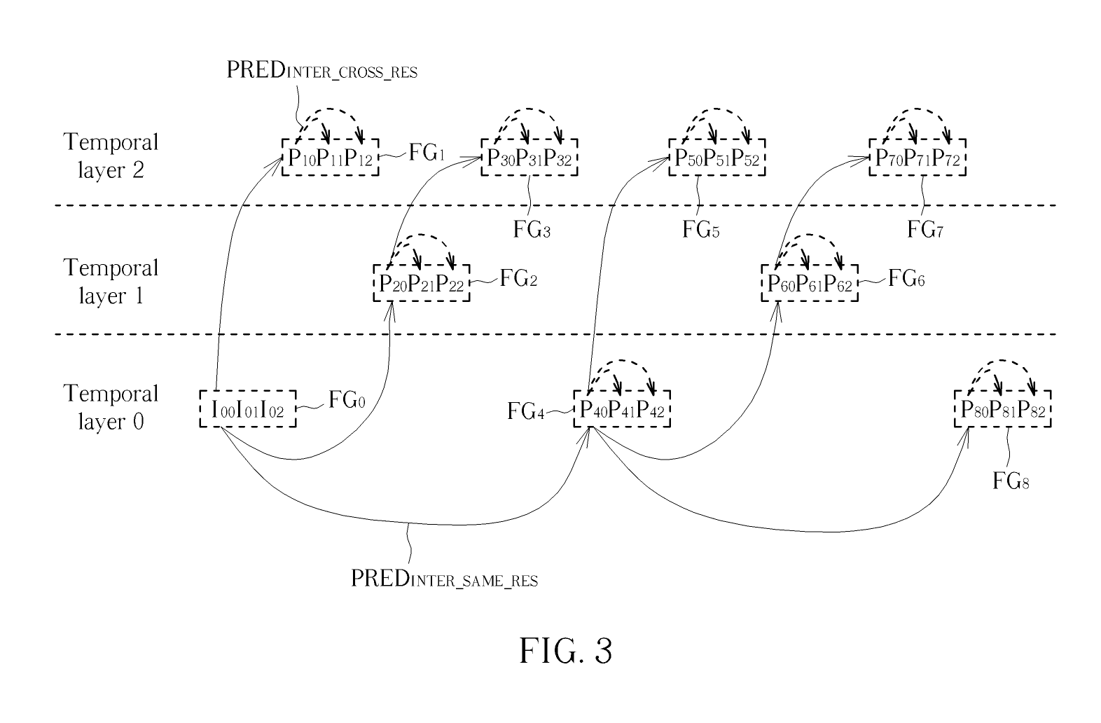

FIG. 3 is a diagram illustrating a second reference frame structure according to an embodiment of the present invention. In this embodiment, a reference frame structure for temporal scaling with at least two temporal layers and spatial scaling with at least two spatial layers is proposed. By way of example, but not limitation, the reference frame structure in FIG. 3 is applied to three temporal layers and three spatial layers. The major difference between the reference frame structures shown in FIG. 3 and FIG. 2 is that different in-group frames in the same frame group use the same in-group reference frame for cross resolution inter prediction.

In accordance with the reference frame structure illustrated in FIG. 3, the reference frame acquisition circuit 102 performs reference frame acquisition for inter prediction of a first in-group frame in a frame group, and further performs reference frame acquisition for inter prediction of a second in-group frame in the same frame group, where a single reference frame used by the inter prediction of the first in-group frame is intentionally constrained to be an in-group reference frame obtained from reconstructed data of a frame in the same frame group, and a single reference frame used by the inter prediction of the second in-group frame is intentionally constrained to be the same in-group reference frame obtained from reconstructed data of the same frame in the same frame group.

Taking the frame group FG₂ shown in FIG. 3 for example, the frame P₂₀ with the spatial layer index “0” is an out-group frame, and the frame P₂₁ with the spatial layer index “1” and the frame P₂₂ with the spatial layer index “2” are in-group frames. When the frame P₂₀ is being encoded/decoded, the same resolution inter prediction PRED_{INTER}_{_}_{SAME}_{_}_{RES} (which is represented by a solid-line arrow symbol in FIG. 3) is performed upon the frame P₂₀ according to a single out-group reference frame provided by a frame group that is encoded/decoded earlier than the frame group FG₂. In accordance with the proposed reference frame structure shown in FIG. 3, a single out-group reference frame is provided by the nearest frame group with the same or smaller temporal layer index. As shown in FIG. 3, the single out-group reference frame is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₀ in the frame group FG₂ have the same spatial layer index and thus have the same resolution.

When the frame P₂₁ is being encoded/decoded, the cross resolution inter prediction PRED_{INTER}_{_}_{CROSS}_{_}_{RES} (which is represented by a broken-line arrow symbol in FIG. 3) is performed upon the frame P₂₁ according to a single in-group reference frame provided by the frame group FG₂. For example, the single in-group reference frame is obtained from reconstructed data of the frame P₂₀ (i.e., a reconstructed frame of previously encoded/decoded frame P₂₀), where the frames P₂₀ and P₂₁ in the same frame group FG₂ have different spatial layer indices and thus have different resolutions.

When the frame P₂₂ is being encoded/decoded, the cross resolution inter prediction PRED_{INTER}_{_}_{CROSS}_{_}_{RES} (which is represented by a broken-line arrow symbol in FIG. 3) is performed upon the frame P₂₂ according to a single in-group reference frame provided by the frame group FG₂. For example, the single in-group reference frame is also obtained from reconstructed data of the frame P₂₀ (i.e., a reconstructed frame of previously encoded/decoded frame P₂₀), where the frames P₂₀ and P₂₂ in the same frame group FG₂ have different spatial layer indices and thus have different resolutions.

When the proposed reference frame structure shown in FIG. 3 is employed, the minimum number of reference frame buffers required to be implemented in the storage device 10 for encoding/decoding all inter frames under temporal and spatial scaling may be two. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frame (e.g., P₄₀); when the frame P₂₁ is being encoded/decoded, reconstructed data of the frame I₀₀ is kept in the first reference frame buffer due to the fact that reconstructed data of the frame I₀₀ is needed by encoding/decoding of the following frame (e.g., P₄₀), and reconstructed data of the frame P₂₀ is kept in a second reference frame buffer due to the fact that reconstructed data of the frame P₂₀ is needed by encoding/decoding of the current frame and the following frames (e.g., P₂₂ and P₃₀); and when the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀), and reconstructed data of the frame P₂₀ is kept in the second reference frame buffer due to the fact that reconstructed data of the frame P₂₀ is needed by encoding/decoding of the current frame.

However, when the proposed reference frame structure shown in FIG. 3 is employed for a different application (e.g., parallel encoding/decoding), the number of reference frame buffers required to be implemented in the storage device 10 for encoding/decoding all inter frames under temporal and spatial scaling may be larger than the aforementioned minimum value.

With regard to the proposed reference frame structures shown in FIGS. 2-3, encoding/decoding of different in-group frames in the same frame group uses different in-group reference frames or the same in-group reference frame for cross resolution inter prediction. Alternatively, encoding/decoding of at least one frame in a frame group may use an out-group reference frame for cross resolution inter prediction.

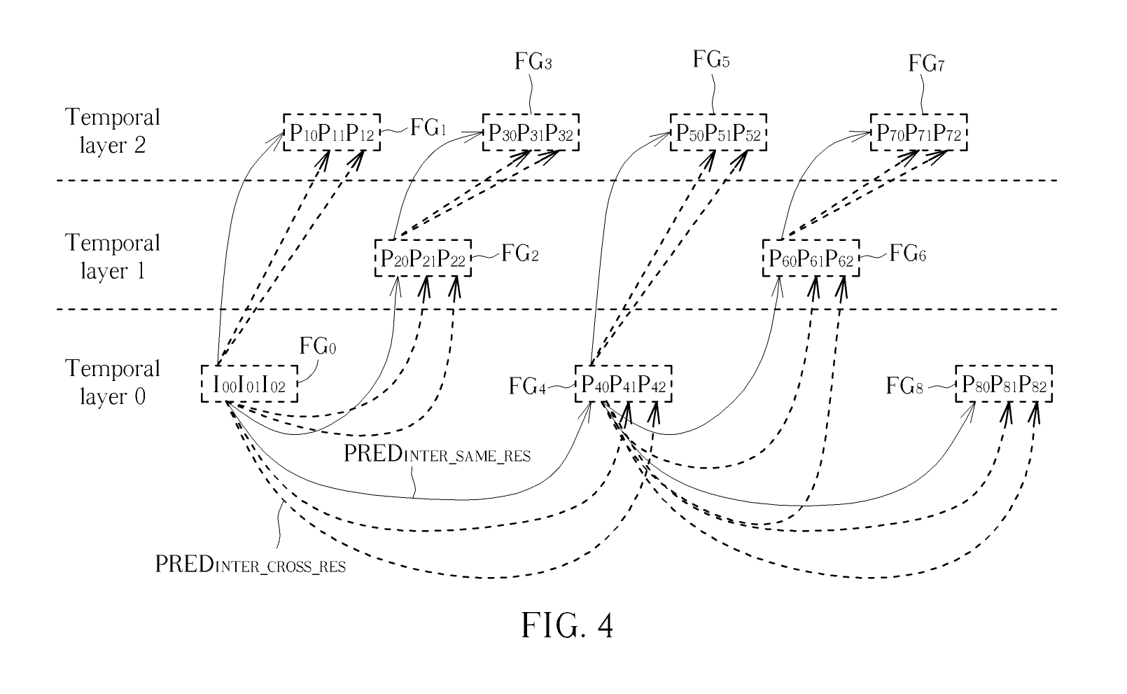

FIG. 4 is a diagram illustrating a third reference frame structure according to an embodiment of the present invention. In this embodiment, a reference frame structure for temporal scaling with at least two temporal layers and spatial scaling with at least two spatial layers is proposed. Byway of example, but not limitation, the reference frame structure in FIG. 4 is applied to three temporal layers and three spatial layers. The major difference between the reference frame structures illustrated in FIG. 4 and FIGS. 2-3 is that each frame in the same frame group uses an out-group reference frame for inter prediction.

In accordance with the reference frame structure illustrated in FIG. 4, the reference frame acquisition circuit 102 performs reference frame acquisition for inter prediction of each frame in a frame group. A single reference frame used by same resolution inter prediction of one first frame in a first frame group is intentionally constrained by the reference frame acquisition circuit 102 to be an out-group reference frame obtained from reconstructed data of one second frame in a second frame group, where the first frame and the obtained second frame have the same resolution, and a temporal layer index of the obtained second frame is smaller than or the same as a temporal layer index of the first frame to be encoded/decoded. For example, when the first frame to be encoded/decoded has a temporal layer index “2”, the second frame with a temporal layer index “2” or “1” or “0” may be obtained; when the first frame has a temporal layer index “1”, the second frame with a temporal layer index “1” or “0” may be obtained; and when the first frame has a temporal layer index “0”, the second frame with a temporal layer index “0” may be obtained. In addition, a single reference frame used by cross resolution inter prediction of another first frame in the first frame group is intentionally constrained by the reference frame acquisition circuit 102 to be an out-group reference frame obtained from reconstructed data of a second frame (e.g., the same second frame referenced by the same resolution inter prediction) in the second frame group, where the another first frame and the obtained second frame have different resolutions, and the temporal layer index of the obtained second frame is smaller than or the same as a temporal layer index of the another first frame to be encoded/decoded.

Taking the frame group FG₂ for example, the frame P₂₀ with the spatial layer index “0” is encoded/decoded based on same resolution inter prediction, and each of the frame P₂₁ with the spatial layer index “1” and the frame P₂₂ with the spatial layer index “2” is encoded/decoded based on cross resolution inter prediction. When the frame P₂₀ is being encoded/decoded, the same resolution inter prediction PRED_{INTER}_{_}_{SAME}_{_}_{RES} (which is represented by a solid-line arrow symbol in FIG. 4) is performed upon the frame P₂₀ according to a single out-group reference frame provided by a frame group that is encoded/decoded earlier than the frame group FG₂. In accordance with the proposed reference frame structure shown in FIG. 4, a single out-group reference frame is provided by the nearest frame group with the same or smaller temporal layer index. As shown in FIG. 4, the single out-group reference frame is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₀ in the frame group FG₂ have the same spatial layer index and thus have the same resolution.

When the frame P₂₁ is being encoded/decoded, the cross resolution inter prediction PRED_{INTER}_{_}_{CROSS}_{_}_{RES} (which is represented by a broken-line arrow symbol in FIG. 4) is performed upon the frame P₂₁ according to a single out-group reference frame provided by a frame group that is encoded/decoded earlier than the frame group FG₂. For example, the single out-group reference frame is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₁ in the frame group FG₂ have different spatial layer indices and thus have different resolutions.

When the frame P₂₂ is being encoded/decoded, the cross resolution inter prediction PRED_{INTER}_{_}_{CROSS}_{_}_{RES} (which is represented by a broken-line arrow symbol in FIG. 4) is performed upon the frame P₂₂ according to a single out-group reference frame provided by a frame group that is encoded/decoded earlier than the frame group FG₂. For example, the single out-group reference frame is also obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₂ in the frame group FG₂ have different spatial layer indices and thus have different resolutions.

In one exemplary design, the cross resolution inter prediction PRED_{INTER}_{_}_{CROSS}_{_}_{RES} of a frame (e.g., frame P₂₁/P₂₂) may be performed using a resolution reference frame (RRF) mechanism as proposed in VP9 video coding standard. In another exemplary design, the cross resolution inter prediction PRED_{INTER}_{_}_{CROSS}_{_}_{RES} of a frame (e.g., frame P₂₁/P₂₂) may require that a resolution of the frame should be larger than resolution of the cross-group reference frame. However, these are for illustrative purposes only, and are not meant to be limitations of the present invention.

When the proposed reference frame structure shown in FIG. 4 is employed, the minimum number of reference frame buffers required to be implemented in the storage device 10 for encoding/decoding all inter frames under temporal and spatial scaling may be two. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frames (e.g., P₂₁, P₂₂, P₄₀, P₄₁ and P₄₂); when the frame P₂₁ is being encoded/decoded, reconstructed data of the frame I₀₀ is kept in the first reference frame buffer due to the fact that reconstructed data of the frame I₀₀ is needed by encoding/decoding of the following frames (e.g., P₂₂, P₄₀, P₄₁ and P₄₂), and reconstructed data of the frame P₂₀ is kept in a second reference frame buffer due to the fact that reconstructed data of the frame P₂₀ is needed by encoding/decoding of the current frame and the following frames (e.g., P₃₀, P₃₁ and P₃₂); and when the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀, P₄₁ and P₄₂), and reconstructed data of the frame P₂₀ is kept in the second reference frame buffer due to the fact that reconstructed data of the frame P₂₀ is needed by encoding/decoding of the following frames (e.g., P₃₀, P₃₁ and P₃₂).

However, when the proposed reference frame structure shown in FIG. 4 is employed for a different application (e.g., parallel encoding/decoding), the number of reference frame buffers required to be implemented in the storage device 10 for encoding/decoding all inter frames under temporal and spatial scaling may be larger than the aforementioned minimum value.

With regard to the proposed reference frame structure shown in FIG. 4, encoding/decoding of each in-group frame in a frame group uses only a single in-group reference frame for cross resolution inter prediction. Alternatively, encoding/decoding of at least one in-group frame in a frame group may use multiple in-group reference frames for cross resolution inter prediction.

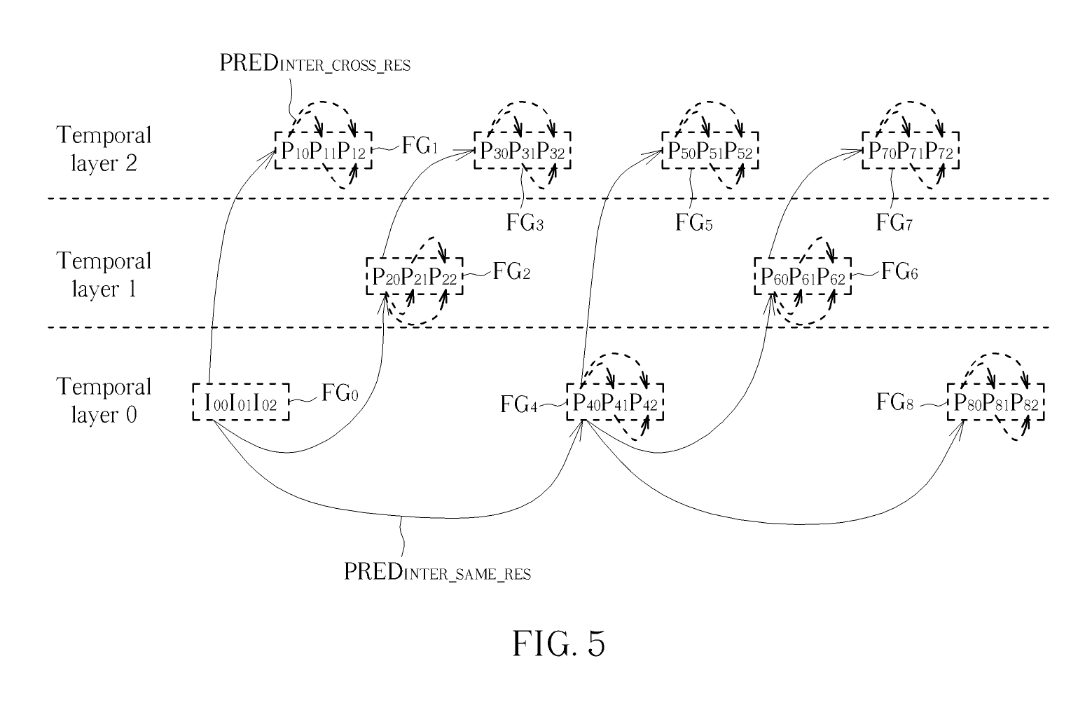

FIG. 5 is a diagram illustrating a fourth reference frame structure according to an embodiment of the present invention. In this embodiment, a reference frame structure for temporal scaling with at least two temporal layers and spatial scaling with at least two spatial layers is proposed. Byway of example, but not limitation, the reference frame structure in FIG. 5 is applied to three temporal layers and three spatial layers. The major difference between the reference frame structures illustrated in FIG. 5 and FIG. 2 is that each in-group frame in a frame group can use one or more in-group reference frames for cross resolution inter prediction.

In accordance with the reference frame structure illustrated in FIG. 5, the reference frame acquisition circuit 102 performs reference frame acquisition for inter prediction of an out-group frame in a frame group, and further performs reference frame acquisition for inter prediction of each in-group frame in the same frame group, where a single reference frame used by the inter prediction of the out-group frame is intentionally constrained to be an out-group reference frame obtained from reconstructed data of one frame in a different frame group, and at least one reference frame used by the inter prediction of each in-group frame is intentionally constrained to be at least one in-group reference frame obtained from reconstructed data of at least one frame in the same frame group.

It should be noted that a temporal layer index of the obtained out-group reference frame is smaller than or the same as a temporal layer index of the out-group frame to be encoded/decoded. For example, when the out-group frame has a temporal layer index “2”, the out-group reference frame with a temporal layer index “2” or “1” or “0” may be obtained; when the out-group frame has a temporal layer index “1”, the out-group reference frame with a temporal layer index “1” or “0” may be obtained; and when the out-group frame has a temporal layer index “0”, the out-group reference frame with a temporal layer index “0” may be obtained.

Taking the frame group FG₂ shown in FIG. 5 for example, the frame P₂₀ with the spatial layer index “0” is an out-group frame, and the frame P₂₁ with the spatial layer index “1” and the frame P₂₂ with the spatial layer index “2” are in-group frames. When the frame P₂₀ is being encoded/decoded, the same resolution inter prediction PRED_{INTER}_{_}_{SAME}_{_}_{RES} (which is represented by a solid-line arrow symbol in FIG. 5) is performed upon the frame P₂₀ according to a single out-group reference frame provided by a frame group that is encoded/decoded earlier than the frame group FG₂. In accordance with the proposed reference frame structure shown in FIG. 5, a single out-group reference frame is provided by the nearest frame group with the same or smaller temporal layer index. As shown in FIG. 5, the single out-group reference frame is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₀ in the frame group FG₂ have the same spatial layer index and thus have the same resolution.

When the frame P₂₁ is being encoded/decoded, the cross resolution inter prediction PRED_{INTER}_{_}_{CROSS}_{_}_{RES} (which is represented by a broken-line arrow symbol in FIG. 5) is performed upon the frame P₂₁ according to only one in-group reference frame provided by the frame group FG₂. For example, the single in-group reference frame is obtained from reconstructed data of the frame P₂₀ (i.e., a reconstructed frame of previously encoded/decoded frame P₂₀), where the frames P₂₀ and P₂₁ in the same frame group FG₂ have different spatial layer indices and thus have different resolutions.

When the frame P₂₂ is being encoded/decoded, the cross resolution inter prediction PRED_{INTER}_{_}_{CROSS}_{_}_{RES} (which is represented by two broken-line arrow symbols in FIG. 5) is performed upon the frame P₂₂ according to multiple in-group reference frames provided by the frame group FG₂. For example, one in-group reference frame is obtained from reconstructed data of the frame P₂₁ (i.e., a reconstructed frame of previously encoded/decoded frame P₂₁), and another in-group reference frame is obtained from reconstructed data of the frame P₂₀ (i.e., a reconstructed frame of previously encoded/decoded frame P₂₀), where the frames P₂₀, P₂₁ and P₂₂ in the same frame group FG₂ have different spatial layer indices and thus have different resolutions.

When the proposed reference frame structure shown in FIG. 5 is employed, the minimum number of reference frame buffers required to be implemented in the storage device 10 for encoding/decoding all inter frames under temporal and spatial scaling may be three. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frame (e.g., P₄₀); when the frame P₂₁ is being encoded/decoded, reconstructed data of the frame I₀₀ is kept in the first reference frame buffer due to the fact that reconstructed data of the frame I₀₀ is needed by encoding/decoding of the following frame (e.g., P₄₀), and reconstructed data of the frame P₂₀ is kept in a second reference frame buffer due to the fact that reconstructed data of the frame P₂₀ is needed by encoding/decoding of the current frame and the following frames (e.g., P₂₂ and P₃₀); and when the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame P₂₀ is kept in the second reference frame buffer due to the fact that reconstructed data of the frame P₂₀ is needed by encoding/decoding of the current frame and the following frame (e.g., P₃₀), and reconstructed data of the frame P₂₁ is kept in a third reference frame buffer due to the fact that reconstructed data of the frame P₂₁ is needed by encoding/decoding of the current frame.

However, when the proposed reference frame structure shown in FIG. 5 is employed for a different application (e.g., parallel encoding/decoding), the number of reference frame buffers required to be implemented in the storage device 10 for encoding/decoding all inter frames under temporal and spatial scaling may be larger than the aforementioned minimum value.

With regard to the proposed reference frame structure shown in FIG. 5, encoding/decoding of each in-group frame in a frame group uses a single in-group reference frame for cross resolution inter prediction. Alternatively, encoding/decoding of at least one frame in a frame group may use a single in-group reference frame for cross resolution inter prediction and may further use a single out-group reference frame for same resolution inter prediction.

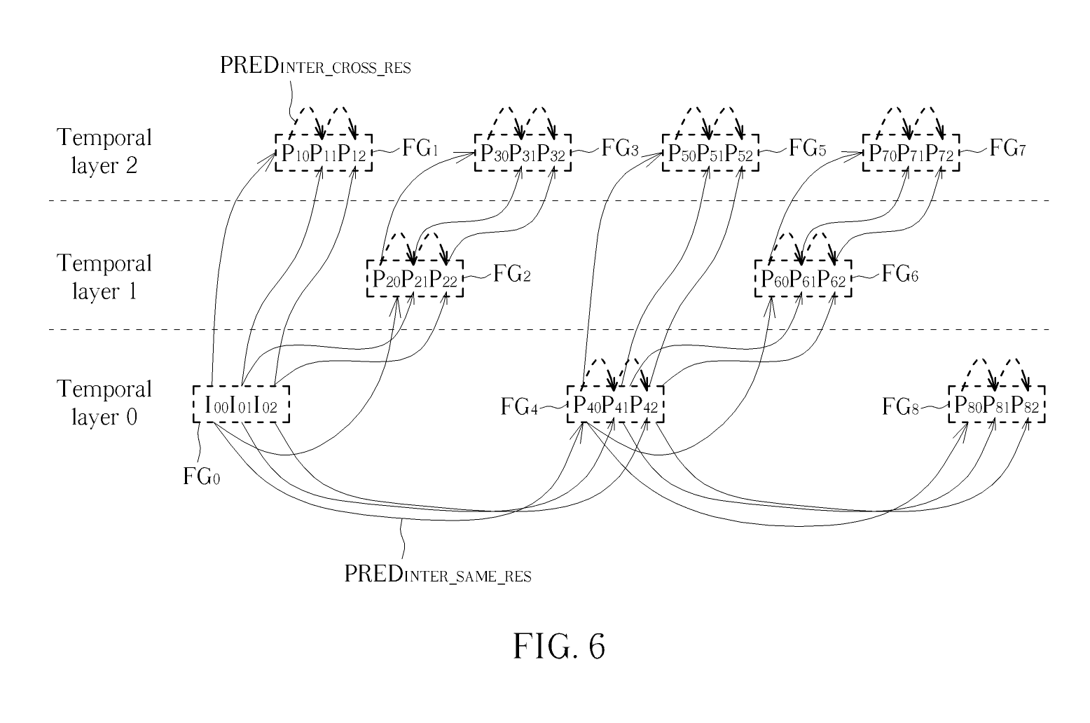

FIG. 6 is a diagram illustrating a fifth reference frame structure according to an embodiment of the present invention. In this embodiment, a reference frame structure for temporal scaling with at least two temporal layers and spatial scaling with at least two spatial layers is proposed. Byway of example, but not limitation, the reference frame structure in FIG. 6 is applied to three temporal layers and three spatial layers. The major difference between the reference frame structures illustrated in FIG. 6 and FIG. 2 is that at least one frame in a frame group can use one in-group frame and one out-group reference frame for inter prediction.

In accordance with the reference frame structure illustrated in FIG. 6, the reference frame acquisition circuit 102 performs reference frame acquisition for inter prediction of each frame in a frame group. A single reference frame used by the inter prediction of one frame in a first frame group is intentionally constrained to be an out-group reference frame obtained from reconstructed data of one frame with the same resolution in a second frame group, where a temporal layer index of the obtained out-group reference frame is smaller than or the same as a temporal layer index of the frame to be encoded/decoded. For example, when the frame to be encoded/decoded has a temporal layer index “2”, the out-group reference frame with a temporal layer index “2” or “1” or “0” may be obtained; when the frame to be encoded/decoded has a temporal layer index “1”, the out-group reference frame with a temporal layer index “1” or “0” may be obtained; and when the frame to be encoded/decoded has a temporal layer index “0”, the out-group reference frame with a temporal layer index “0” may be obtained. Multiple reference frames used by the inter prediction of another frame in the first frame group is intentionally constrained to include an out-group reference frame obtained from reconstructed data of one frame with the same resolution in the second frame group and an in-group reference frame obtained from reconstructed data of one frame with a different resolution in the same first frame group, where a temporal layer index of the obtained out-group reference frame is smaller than or the same as a temporal layer index of the another frame to be encoded/decoded. For example, when the another frame to be encoded/decoded has a temporal layer index “2”, the out-group reference frame with a temporal layer index “2” or “1” or “0” may be obtained; when the another frame to be encoded/decoded has a temporal layer index “1”, the out-group reference frame with a temporal layer index “1” or “0” may be obtained; and when the another frame to be encoded/decoded has a temporal layer index “0”, the out-group reference frame with a temporal layer index “0” may be obtained.

Taking the frame group FG₂ shown in FIG. 6 for example, the frame P₂₀ with the spatial layer index “0” is encoded/decoded based on same resolution inter prediction using only a single reference frame, and each of the frame P₂₁ with the spatial layer index “1” and the frame P₂₂ with the spatial layer index “2” is encoded/decoded based on same resolution inter prediction using only a single reference frame and cross resolution inter prediction using only a single in-group reference frame. When the frame P₂₀ is being encoded/decoded, the same resolution inter prediction PRED_{INTER}_{_}_{SAME}_{_}_{RES} (which is represented by a solid-line arrow symbol in FIG. 6) is performed upon the frame P₂₀ according to a single out-group reference frame provided by a frame group that is encoded/decoded earlier than the frame group FG₂. In accordance with the proposed reference frame structure shown in FIG. 6, a single out-group reference frame is provided by the nearest frame group with the same or smaller temporal layer index. As shown in FIG. 6, the single out-group reference frame is obtained from reconstructed data of the frame I₀₀ (i.e., a reconstructed frame of previously encoded/decoded frame I₀₀ in the nearest frame group with the smaller temporal layer index), where the frame I₀₀ in the frame group FG₀ and the frame P₂₀ in the frame group FG₂ have the same spatial layer index and thus have the same resolution.

When the frame P₂₁ is being encoded/decoded, the cross resolution inter prediction PRED_{INTER}_{_}_{CROSS}_{_}_{RES} (which is represented by a broken-line arrow symbol in FIG. 6) is performed upon the frame P₂₁ according to a single in-group reference frame provided by the frame group FG₂, and the same resolution inter prediction PRED_{INTER}_{_}_{SAME}_{_}_{RES} (which is represented by a solid-line arrow symbol in FIG. 6) is also performed upon the frame P₂₁ according to a single out-group reference frame provided by a frame group that is encoded/decoded earlier than the frame group FG₂. In accordance with the proposed reference frame structure shown in FIG. 6, the single out-group reference frame is provided by the nearest frame group with the same or smaller temporal layer index. As shown in FIG. 6, the single out-group reference frame is obtained from reconstructed data of the frame I₀₁ (i.e., a reconstructed frame of previously encoded/decoded frame I₀₁ in the nearest frame group with the smaller temporal layer index), where the frame I₀₁ in the frame group FG₀ and the frame P₂₁ in the frame group FG₂ have the same spatial layer index and thus have the same resolution. In addition, the single in-group reference frame is obtained from reconstructed data of the frame P₂₀ (i.e., a reconstructed frame of previously encoded/decoded frame P₂₀), where the frames P₂₀ and P₂₁ in the same frame group FG₂ have different spatial layer indices and thus have different resolutions.

When the frame P₂₂ is being encoded/decoded, the cross resolution inter prediction PRED_{INTER}_{_}_{CROSS}_{_}_{RES} (which is represented by a broken-line arrow symbol in FIG. 6) is performed upon the frame P₂₂ according to a single in-group reference frame provided by the frame group FG₂, and the same resolution inter prediction PRED_{INTER}_{_}_{SAME}_{_}_{RES} (which is represented by a solid-line arrow symbol in FIG. 6) is also performed upon the frame P₂₂ according to a single out-group reference frame provided by a frame group that is encoded/decoded earlier than the frame group FG₂. In accordance with the proposed reference frame structure shown in FIG. 6, the single out-group reference frame is provided by the nearest frame group with the same or smaller temporal layer index. As shown in FIG. 6, the single out-group reference frame is obtained from reconstructed data of the frame I₀₂ (i.e., a reconstructed frame of previously encoded/decoded frame I₀₂ in the nearest frame group with the smaller temporal layer index), where the frame I₀₂ in the frame group FG₀ and the frame P₂₂ in the frame group FG₂ have the same spatial layer index and thus have the same resolution. In addition, the single in-group reference frame is obtained from reconstructed data of the frame P₂₁ (i.e., a reconstructed frame of previously encoded/decoded frame P₂₁), where the frames P₂₁ and P₂₂ in the same frame group FG₂ have different spatial layer indices and thus have different resolutions.

In one exemplary design, inter prediction of a frame with the smallest resolution in a frame group may only include same resolution inter prediction. In another exemplary design, inter prediction of a frame that does not have the smallest resolution in a frame group may include both of same resolution inter prediction and cross resolution inter prediction. However, these are for illustrative purposes only, and are not meant to be limitations of the present invention.

When the proposed reference frame structure shown in FIG. 6 is employed, the minimum number of reference frame buffers required to be implemented in the storage device 10 for encoding/decoding all inter frames under temporal and spatial scaling may be six. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frame (e.g., P₄₀), reconstructed data of the frame I₀₁ is kept in a second reference frame buffer due to the fact that reconstructed data of the frame I₀₁ is needed by encoding/decoding of the following frames (e.g., P₂₁ and P₄₁), and reconstructed data of the frame I₀₂ is kept in a third reference frame buffer due to the fact that reconstructed data of the frame I₀₂ is needed by encoding/decoding of the following frames (e.g., P₂₂ and P₄₂).

When the frame P₂₁ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the current frame and the following frame (e.g., P₄₁), reconstructed data of the frame I₀₂ is kept in the third reference frame buffer due to the fact that reconstructed data of the frame I₀₂ is needed by encoding/decoding of the following frames (e.g., P₂₂ and P₄₂), and reconstructed data of the frame P₂₀ is kept in a fourth reference frame buffer due to the fact that reconstructed data of the frame P₂₀ is needed by encoding/decoding of the current frame and the following frame (e.g., P₃₀).

When the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the following frame (e.g., P₄₁), reconstructed data of the frame I₀₂ is kept in the third reference frame buffer due to the fact that reconstructed data of the frame I₀₂ is needed by encoding/decoding of the current frame and the following frame (e.g., P₄₂), reconstructed data of the frame P₂₀ is kept in the fourth reference frame buffer due to the fact that reconstructed data of the frame P₂₀ is needed by encoding/decoding of the following frame (e.g., P₃₀), and reconstructed data of the frame P₂₁ is kept in a fifth reference frame buffer due to the fact that reconstructed data of the frame P₂₁ is needed by encoding/decoding of the current frame and the following frame (e.g., P₃₁).

When the frame P₃₀ of the next frame group FG₃ is encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the following frame (e.g., P₄₁), reconstructed data of the frame I₀₂ is kept in the third reference frame buffer due to the fact that reconstructed data of the frame I₀₂ is needed by encoding/decoding of the following frame (e.g., P₄₂), reconstructed data of the frame P₂₀ is kept in the fourth reference frame buffer due to the fact that reconstructed data of the frame P₂₀ is needed by encoding/decoding of the current frame, reconstructed data of the frame P₂₁ is kept in the fifth reference frame buffer due to the fact that reconstructed data of the frame P₂₁ is needed by encoding/decoding of the following frame (e.g., P₃₁), and reconstructed data of the frame P₂₂ is kept in a sixth reference frame buffer due to the fact that reconstructed data of the frame P₂₂ is needed by encoding/decoding of the following frame (e.g., P₃₂).

However, when the proposed reference frame structure shown in FIG. 6 is employed for a different application (e.g., parallel encoding/decoding), the number of reference frame buffers required to be implemented in the storage device 10 for encoding/decoding all inter frames under temporal and spatial scaling may be larger than the aforementioned minimum value.

With regard to the proposed reference frame structure shown in FIG. 5, encoding/decoding of at least one in-group frame in a frame group may use multiple in-group reference frames for cross resolution inter prediction. With regard to the proposed reference frame structure shown in FIG. 6, encoding/decoding of at least one frame in a frame group may use a single in-group reference frame for cross resolution inter prediction and a single out-group reference frame for same resolution inter prediction. Alternatively, encoding/decoding of at least one frame in a frame group may use multiple in-group reference frames for cross resolution inter prediction and a single out-group reference frame for same resolution inter prediction.

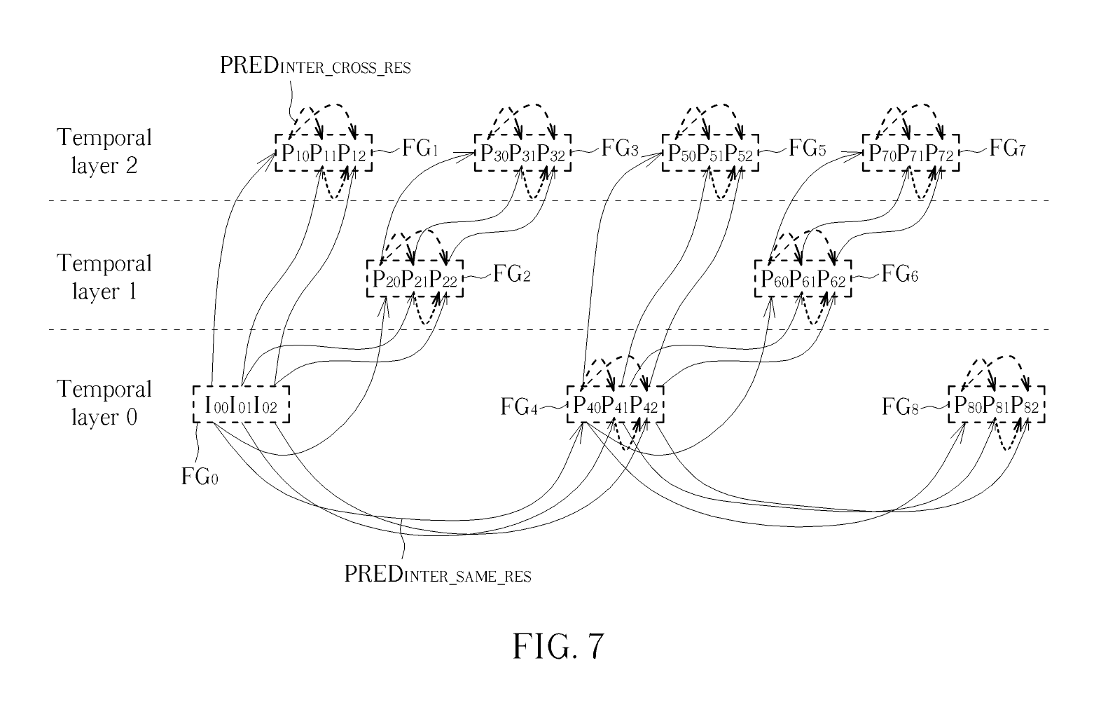

FIG. 7 is a diagram illustrating a sixth reference frame structure according to an embodiment of the present invention. The reference frame structure shown in FIG. 7 may be set by combining the reference frame structure shown in FIG. 5 and the reference frame structure shown in FIG. 6. As a person skilled in the art can readily understand details of the reference frame structure shown in FIG. 7 after reading above paragraphs directed to the reference frame structures shown in FIG. 5 and FIG. 6, further description of the constrained reference frame acquisition associated with the reference frame structure shown in FIG. 7 is omitted here for brevity.

When the proposed reference frame structure shown in FIG. 7 is employed, the minimum number of reference frame buffers required to be implemented in the storage device 10 for encoding/decoding all inter frames under temporal and spatial scaling may be six. For example, when the frame P₂₀ is being encoded/decoded, reconstructed data of the frame I₀₀ is kept in a first reference frame buffer due to the fact that reconstructed data of the frame I₀₀ is needed by encoding/decoding of the current frame and the following frame (e.g., P₄₀), reconstructed data of the frame I₀₁ is kept in a second reference frame buffer due to the fact that reconstructed data of the frame I₀₁ is needed by encoding/decoding of the following frames (e.g., P₂₁ and P₄₁), and reconstructed data of the frame I₀₂ is kept in a third reference frame buffer due to the fact that reconstructed data of the frame I₀₂ is needed by encoding/decoding of the following frames (e.g., P₂₂ and P₄₂).

When the frame P₂₁ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the current frame and the following frame (e.g., P₄₁), reconstructed data of the frame I₀₂ is kept in the third reference frame buffer due to the fact that reconstructed data of the frame I₀₂ is needed by encoding/decoding of the following frames (e.g., P₂₂ and P₄₂), and reconstructed data of the frame P₂₀ is kept in a fourth reference frame buffer due to the fact that reconstructed data of the frame P₂₀ is needed by encoding/decoding of the current frame and the following frames (e.g., P₂₂ and P₃₀).

When the frame P₂₂ is being encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the following frame (e.g., P₄₁), reconstructed data of the frame I₀₂ is kept in the third reference frame buffer due to the fact that reconstructed data of the frame I₀₂ is needed by encoding/decoding of the current frame and the following frame (e.g., P₄₂), reconstructed data of the frame P₂₀ is kept in the fourth reference frame buffer due to the fact that reconstructed data of the frame P₂₀ is needed by encoding/decoding of the current frame and the following frame (e.g., P₃₀), and reconstructed data of the frame P₂₁ is kept in a fifth reference frame buffer due to the fact that reconstructed data of the frame P₂₁ is needed by encoding/decoding of the current frame and the following frame (e.g., P₃₁).

When the frame P₃₀ of the next frame group FG₃ is encoded/decoded, reconstructed data of the frame I₀₀ is kept in the first reference frame buffer due to the fact that reconstructed data of the frame I₀₀ is needed by encoding/decoding of the following frame (e.g., P₄₀), reconstructed data of the frame I₀₁ is kept in the second reference frame buffer due to the fact that reconstructed data of the frame I₀₁ is needed by encoding/decoding of the following frame (e.g., P₄₁), reconstructed data of the frame I₀₂ is kept in the third reference frame buffer due to the fact that reconstructed data of the frame I₀₂ is needed by encoding/decoding of the following frame (e.g., P₄₂), reconstructed data of the frame P₂₀ is kept in the fourth reference frame buffer due to the fact that reconstructed data of the frame P₂₀ is needed by encoding/decoding of the current frame, reconstructed data of the frame P₂₁ is kept in the fifth reference frame buffer due to the fact that reconstructed data of the frame P₂₁ is needed by encoding/decoding of the following frame (e.g., P₃₁), and reconstructed data of the frame P₂₂ is kept in a sixth reference frame buffer due to the fact that reconstructed data of the frame P₂₂ is needed by encoding/decoding of the following frame (e.g., P₃₂).

However, when the proposed reference frame structure shown in FIG. 7 is employed for a different application (e.g., parallel encoding/decoding), the number of reference frame buffers required to be implemented in the storage device 10 for encoding/decoding all inter frames under temporal and spatial scaling may be larger than the aforementioned minimum value.

It should be noted that, in each of the exemplary reference frame structures shown in FIGS. 2-7, the reference frame (s) obtained by the constrained reference frame acquisition for inter prediction of a frame to be encoded/decoded are for illustrative purposes only and are not meant to be limitations of the present invention. Any video encoder/decoder using a reference frame acquisition design with a constraint on reference frame (s) obtained for inter prediction of frames that are encoded/decoded for a video bitstream with temporal and/or spatial scalability falls within the scope of the present invention.

Moreover, in each of the exemplary reference frame structures shown in FIGS. 2-7, frame types of frames included in each frame group are for illustrative purpose only and are not meant to be limitations of the present invention. In practice, there is no limitation on frame types of frames included in the same frame group. In other embodiments, frames included in the same frame group do not necessarily have the same frame type. Taking the first frame group FG₀ shown in each of FIGS. 2-7 for example, it may only include intra frames (e.g., I₀₀, I₀₁ and I₀₂) in one exemplary design, and may include one intra frame (e.g., I₀₀) and two inter frames (e.g., P₀₁ and P₀₂) in another exemplary design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inter prediction method comprising:
performing reference frame acquisition for inter prediction of a first frame in a first frame group, wherein at least one reference frame used by the inter prediction of the first frame is intentionally constrained to comprise at least one first reference frame obtained from reconstructed data of at least one second frame in the first frame group, the first frame group comprises at least one first frame, including the first frame, and the at least one second frame, and frames in the first frame group have a same image content but different resolutions; and
performing the inter prediction of the first frame according to the at least one reference frame.

2. The inter prediction method of claim 1, wherein the at least one first reference frame comprises a single reference frame only.

3. The inter prediction method of claim 1, wherein the at least one first frame comprises a plurality of first frames, and inter prediction of each of the first frames is performed based on the same at least one first reference frame.

4. The inter prediction method of claim 3, wherein the at least one second frame comprises a single frame only, and among all frames in the first frame group, the single frame has a smallest resolution.

5. The inter prediction method of claim 1, wherein the inter prediction of the first frame is performed under a prediction mode with a zero motion vector.

6. The inter prediction method of claim 1, wherein each of the at least one second frame has a resolution smaller than a resolution of the first frame.

7. The inter prediction method of claim 1, wherein the inter prediction of the first frame is performed using a resolution reference frame (RRF) mechanism.

8. The inter prediction method of claim 1, wherein the at least one first reference frame comprises a plurality of different reference frames.

9. The inter prediction method of claim 1, wherein the at least one reference frame is further intentionally constrained to comprise at least one second reference frame obtained from reconstructed data of at least one frame in a second frame group, frames in the second frame group have a same image content but different resolutions, and one of the frames in the first frame group and one of the frames in the second frame group have a same resolution.

10. The inter prediction method of claim 9, wherein the second frame group corresponds to a temporal layer with a temporal layer index same as a temporal layer index of a temporal layer to which the first frame group corresponds.

11. The inter prediction method of claim 9, wherein the second frame group corresponds to a temporal layer with a temporal layer index smaller than a temporal layer index of a temporal layer to which the first frame group corresponds.

12. The inter prediction method of claim 9, wherein the at least one first reference frame comprises a single reference frame only, and the at least one second reference frame comprises a single reference frame only.

13. The inter prediction method of claim 9, wherein the at least one second reference frame comprises a reference frame with a resolution equal to a resolution of the first frame.

14. An inter prediction method comprising:
performing reference frame acquisition for inter prediction of a first frame in a first frame group that comprises frames with a same image content but different resolutions, wherein at least one reference frame used by the inter prediction of the first frame is intentionally constrained to comprise at least one first reference frame obtained from reconstructed data of at least one second frame in a second frame group that comprises frames with a same image content but different resolutions, one frame in the first frame group and one frame in the second frame group have a same resolution, and the at least one first reference frame comprises a reference frame having a resolution different from a resolution of the first frame; and
performing the inter prediction of the first frame according to the at least one reference frame.

15. The inter prediction method of claim 14, wherein the at least one first reference frame comprises a single reference frame only.

16. The inter prediction method of claim 14, wherein among the frames in the first frame group, the first frame does not have a smallest resolution.

17. The inter prediction method of claim 14, wherein the second frame group corresponds to a temporal layer with a temporal layer index same as a temporal layer index of a temporal layer to which the first frame group corresponds.

18. The inter prediction method of claim 14, wherein the second frame group corresponds to a temporal layer with a temporal layer index smaller than a temporal layer index of a temporal layer to which the first frame group corresponds.

19. An inter prediction device comprising:
a reference frame acquisition circuit, arranged to perform reference frame acquisition for inter prediction of a first frame in a first frame group, wherein at least one reference frame used by the inter prediction of the first frame is intentionally constrained by the reference frame acquisition circuit to comprise at least one first reference frame obtained from reconstructed data of at least one second frame in the first frame group, and the first frame group comprises at least one first frame, including the first frame, and the at least one second frame, and frames in the first frame group have a same image content but different resolutions; and
an inter prediction circuit, arranged to perform the inter prediction of the first frame according to the at least one reference frame.

20. An inter prediction device comprising:
a reference frame acquisition circuit, arranged to perform reference frame acquisition for inter prediction of a first frame in a first frame group that comprises frames with a same image content but different resolutions, wherein at least one reference frame used by the inter prediction of the first frame is intentionally constrained by reference frame acquisition circuit to comprise at least one first reference frame obtained from reconstructed data of at least one second frame in a second frame group that comprises frames with a same image content but different resolutions, one frame in the first frame group and one frame in the second frame group have a same resolution, and the at least one first reference frame comprises a reference frame having a resolution different from a resolution of the first frame; and
an inter prediction circuit, arranged to perform the inter prediction of the first frame according to the at least one reference frame.
